(19) United States
(12) Patent Application Publication
(10) Pub. No.: US 2010/0021251 A1
(43) Pub. Date: Jan. 28, 2010

(54) DRILL BIT

(76) Inventors: M. Duane Horton, Provo, UT (US); Nathan M. Horton, Salem, UT (US)

Correspondence Address: Workman Nydegger;1000 Eagle Gate Tower, 60 East South Temple, Salt Lake City, UT, 84111, US

(21) Appl. No.: 12/178,269

(22) Filed: Jul. 23, 2008

(51) Int. Cl. B23B 51/06

(52) U.S. Cl. 408/59

(57) ABSTRACT

A drill bit cable of breaking off and milling up the core of a material being drilled is disclosed. The drill bit includes a shaft having an internal fluid conduit, and a working portion adapted to drill a hole. The working portion includes an exterior shoulder and an exit port. The exit port comprises an exit channel that communicates fluid from the fluid conduit to the working portion of the drill bit. The axis of the exit channel is offset from the axis of the drill bit. The exit channel at least partially overlaps the axis of the drill bit in order to define the diameter of the core formed during the drilling process. The exit port also includes a radially expanding interior shoulder that is adapted to break off the core and mill up the core fragments to prevent the core from entering into the fluid conduit.

### BACKGROUND OF THE INVENTION

1. The Field of the Invention

The present invention relates generally to drill bits. More specifically, the present invention relates to a drill bit having a fluid conduit exit port capable of breaking off and milling up the core of the material being drilled to prevent core hang up inside the drill bit and reduce the necessity of manually extracting the core from the drill bit.

2. The Relevant Technology

Drill bits are well known in the art. Drill bits are cutting tools used to create cylindrical holes. Drill motors hold drill bits and rotate them with sufficient axial force to create the hole. There are numerous types of drill bits, which vary is size, shape, and design. Considerations for determining the appropriate type of drill bit to be used include the type and properties of the material to be drilled, the size of the hole to be drilled, and the purpose for drilling the hole (i.e., drilling a hole to receive a fastener, gain access through or inside a material, retrieve a sample of the material to be drilled, or provide a conduit through the material).

As is well known in the art, drilling holes with a “full face bit” in brittle materials, such as concrete, stone, tile, and the like, has posed numerous problems. Such problems include difficulty in drilling the center of the hole where the angular velocity of the drill bit is zero. Other problems include the limited ability to remove drilled fragments and heating of the drill bit face which leads to premature dulling of the drill bit. In an effort to overcome these problems, various advancements have been made in the art. For example, a drill bit having an internal fluid channel extending therethrough has been developed. The fluid channel is designed to deliver fluid to the working surface of the drill bit through an exit port so as to cool and lubricate the working surface of the drill bit and flush away the fragments of the material being drilled. The exit port commonly opens through the center of the working surface of the drill bit, thereby avoiding the problems associated with drilling the center of the hole. This increases the drilling rate, prolongs the life of the drill bit, and reduces the likelihood of the drill bit binding up in the hole.

While drill bits having central fluid channels have reduced some of the above-identified problems with the drilling of brittle materials, these drill bits have considerable drawbacks. For example, as these drill bits drill into a material, a core is formed of the material being drilled, which can extend into the fluid channel of the drill bit. The core can then break off and/or lodge inside of the drill bit, which prevents further penetration of the drill bit into the material. When the core breaks off and/or becomes lodged inside the drill bit, drilling must be stopped so that the core can be removed from the drill bit. Removing the core from the drill bit can be a time consuming, difficult process. Not infrequently the core and/or fragments of the drilled material become lodged within the drill bit so firmly that removing them damages the drill bit. Even if the core does not become lodged inside the drill bit, special efforts may be required to extract the core from the drill bit.

In light of the foregoing, there is a continuing need for a drill bit that overcomes the above shortcomings.

### BRIEF SUMMARY OF THE INVENTION

In general, embodiments of the invention are concerned with a drill bit that has a working portion that breaks off and mills up a core formed during the drilling process. The drill bit prevents the core from significantly entering the interior portion of the drill bit.

In one exemplary embodiment of the invention, a drill bit is provided having a shaft with a coupling portion, a mounting portion, and a working portion. The coupling portion can be adapted to be held and rotated by a drive unit, such as a drill motor. In some embodiments, the coupling portion can be directly held by the drive unit without the need for a coupling joint.

In an exemplary embodiment of the present invention, the mounting portion can be adapted to have a collar, such as a fluid supply collar, mounted thereon. The mounting portion can include slip ring grooves to facilitate coupling of a collar to the drill bit, as well as limit axial movement of the collar on the drill bit. The mounting portion can also include a fluid intake which can communicate fluid from a fluid source to a fluid conduit within the drill bit.

The working portion of the drill bit, according to an exemplary embodiment, can include an exterior shoulder and an exit port. The exterior shoulder can be formed so as to become narrower near the end of the drill bit. Alternatively, the exterior shoulder can also have a generally square shape. The exterior shoulder can be impregnated or coated with an abrasive material, such as diamonds.

In an exemplary embodiment, the exit port includes a substantially cylindrical exit channel. The exit channel can be adapted to communicate fluid from a fluid conduit in the drill bit to exterior surfaces of the working portion. The exit channel can have a central axis that is offset from the central axis of the drill bit. Additionally, the exit channel can overlap the central axis of the drill bit. The offset and overlapping features of the exit channel can assist in creating a smaller core during the drilling process by generating side forces that break up the forming core.

In an exemplary embodiment of the present invention, the exit port includes an interior shoulder. In one example embodiment, the interior shoulder forms a generally frusto-conical shape. The narrow end of the frusto-conical interior shoulder can be positioned adjacent the exit channel so that the exit port radially expands near the end of the drill bit. The interior shoulder can be impregnated or coated with an abrasive material, such as diamonds. The interior shoulder can assist in breaking off and milling up the core formed during the drilling process.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a perspective view of a drill bit according to an exemplary embodiment of the present invention;

FIG. 2 illustrates a side cross-sectional view of the drill bit of FIG. 1;

FIG. 3 illustrates an end view of the drill bit of FIG. 1; and

FIG. 4 illustrates a partial cross-sectional view of the drill bit of FIG. 1 drilling into a surface;

FIG. 5 illustrates a perspective view of a drill bit according to another exemplary embodiment of the present invention;

FIG. 6 illustrates a side cross-sectional view of the drill bit of FIG. 5;

FIG. 7 illustrates a partial cross-sectional view of the drill bit of FIG. 5 drilling into a surface.

### DETAILED DESCRIPTION OF THE PREFERRED EMBODIMENTS

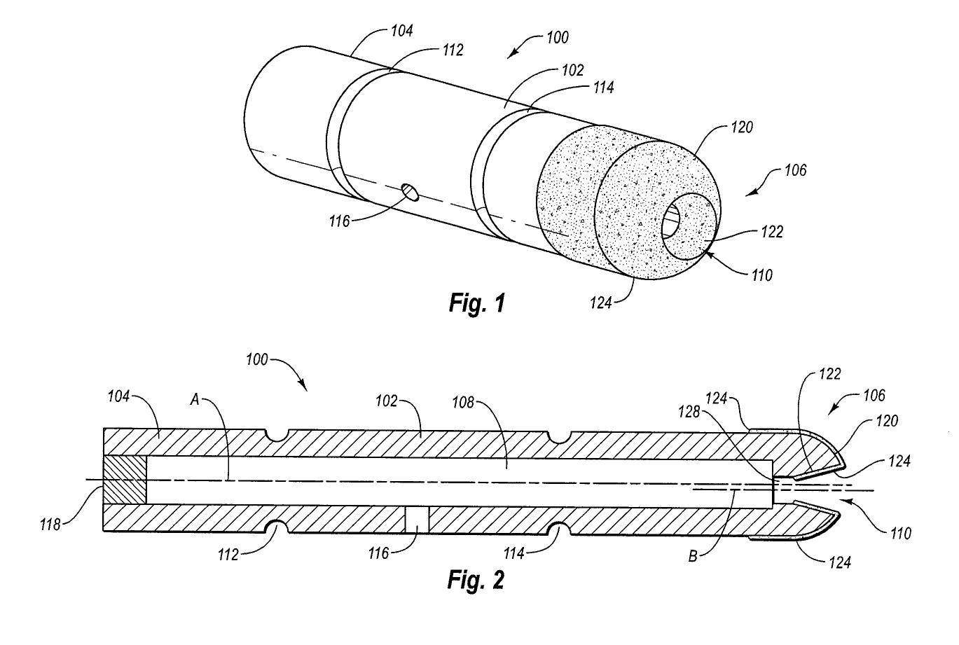

FIGS. 1-4 illustrate a drill bit 100 according to one embodiment of the present invention. Drill bit 100 is configured to drill a straight borehole into or through hard, brittle materials, such as stone, tile, concrete, and the like. Furthermore, drill bit 100 is capable of breaking off the core and milling up fragments of the core to minimize the problems associated with core removal and core hang up.

In the illustrated embodiment, drill bit 100 includes a shaft 102 having a coupling portion 104, a working portion 106, and an internal fluid conduit 108 which opens at working portion 106 through an exit port 110. Drill bit 100 can also include slip ring grooves 112 and 114 to facilitate mounting of a collar on drill bit 100. Drill bit 100 can further include a fluid intake 116 to supply fluid to fluid conduit 108.

Drill bit 100 can provide numerous benefits. For example, fluid conduit 108 can deliver a fluid to working portion 106 of drill bit 100 to lubricate and cool working portion 106 and flush away fragments of the drilled material, thereby reducing wear, increasing penetration rate, and also reducing incidences of drill bit 100 seizing or binding up in a drilled hole. Additionally, as described herein, exit port 110 is adapted to break off the core before the core enters fluid conduit 108, thereby preventing the problems associated with core hang up as described herein.

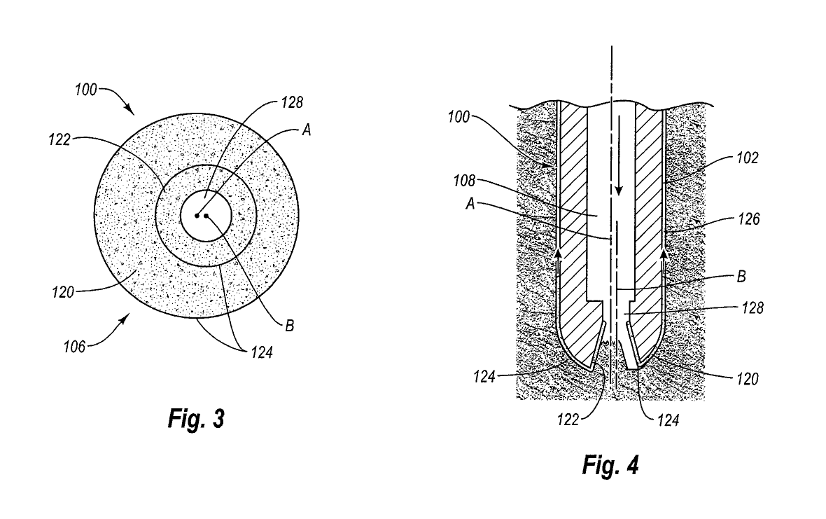

As illustrated in the FIGS. 1 and 3, drill bit 100 is generally cylindrical in shape so as to facilitate the drilling of cylindrical holes. Coupling portion 104 of shaft 102 is adapted to be held directly by a drive unit (not shown), such as a drill motor. Directly coupling the drive unit to shaft 102 eliminates the need for coupling joints, which can cause misalignment. Any misalignment can cause vibrations or side forces that lead to oversized holes, difficulty starting the drill, and excessive, non-uniform wear on the drill bit. In the illustrated embodiment, the exterior surface of coupling portion 104 has a circular cross-section. However, it will be appreciated that the coupling portion 104 can have a cross-sectional shape other than the circular shape illustrated. For example, coupling portion 104 can have a polygon shaped cross-section, such as a rectangular, pentagonal, or hexagonal cross-section. A polygonally shaped coupling portion 104 can increase the torque applied to drill bit 100 without increasing incidences of slippage between the drill motor and drill bit 100.

The exemplary embodiment of drill bit 100 also includes slip ring grooves 112 and 114 to facilitate mounting of a stationary collar (not shown) on drill bit 100. In particular, drill bit 100 can be inserted through an aperture in a stationary collar such that the stationary collar is positioned between slip ring grooves 112 and 114. With the stationary collar so positioned, slip rings (not shown) can be placed on drill bit 100 in slip ring grooves 112 and 114 to limit the movement of the stationary collar along the length of shaft 102.

A stationary collar mounted on drill bit 100 can be formed of a low friction material to enable drill bit 100 to rotate within and relative to the stationary collar. Alternatively, the stationary collar can be equipped with bearings, or other suitable structure, to enable low friction rotation of drill bit 100 relative to the stationary collar.

The illustrated embodiment of drill bit 100 includes a fluid intake 116, which extends through a wall of drill bit 100 and into fluid conduit 108. Fluid intake 116 facilitates fluid communication between fluid conduit 108 and a fluid source, such as a stationary collar mounted on drill bit 100. In particular, the illustrated embodiment of fluid intake 116 is disposed between slip ring grooves 112 and 114 such that fluid from a stationary collar mounted on drill bit 100 can be directed into fluid conduit 108 through fluid intake 116. It will be appreciated however, that fluid intake 116 can be disposed in various other positions on drill bit 100. For example, fluid intake 116 can also extend through the end of coupling portion 104.

As illustrated in FIG. 2, drill bit 100 can also include an end plug 118. End plug 118 can be formed as an integral part of drill bit 100, or end plug 118 can be formed of a separate piece of material that is inserted into the end of coupling portion 104. End plug 118 can be adapted to limit the flow of fluid or other materials through the end of coupling portion 104. Additionally, in some embodiments, end plug 118 can be selectively removable to provide access to fluid conduit 108 near coupling portion 104.

As noted herein, during drilling, a core drill bit creates a core of the material being drilled. If the core is not broken off and milled up as it forms, it will extend into the fluid conduit of the drill bit. If the core fills up and/or break off inside the fluid conduit, drilling penetration can be limited or prevented until the core material is removed from the fluid conduit. As discussed herein, however, drill bit 100 is adapted to break off and mill up a core before the core enters into and/or breaks off in fluid conduit 108. Thus, drill bit 100 is adapted to reduce or prevent incidences of core material either hanging up within or filling up drill bit 100 and the problems associated therewith. The configuration of working portion 106, and in particular exit port 110, provides these advantages.

Working portion 106 includes exterior shoulder 120 and exit port 110. As illustrated in the Figures, exterior shoulder 120 tapers from a diameter substantially equal to that of shaft 102 to a diameter that is about half the diameter of shaft 102. It will be appreciated that the diameter of exterior surface 120 can taper more or less than shown or described herein. Additionally, it will also be appreciated that exterior shoulder 120 can be formed in other configurations without departing from the scope of the present invention. For example, rather than having a diameter that tapers near the end of drill bit 100, exterior shoulder 120 can have a squared or non-rounded configuration such that working portion 106 presents a generally flat working surface at the end of drill bit 100. Additionally or alternatively, exterior shoulder 120 can define one or more blade-type edges to facilitate drilling. Furthermore, exterior shoulder 120 can be covered with an abrasive layer 124, as illustrated, to facilitate the cutting of material. Abrasive layer 124 can include diamonds impregnated or otherwise disposed on exterior shoulder 120. Alternatively, abrasive layer 124 can comprise an etched or otherwise roughened surface on exterior shoulder 120.

In some embodiments, abrasive layer 124 extends at least partially onto shaft 102. As illustrated in FIG. 4, inclusion of abrasive layer 124 on shaft 102 causes drill bit 102 to drill a hole that has a diameter larger than shaft 102, thereby creating a passageway 126 between shaft 102 and the wall of the drilled hole. Passageway 126 enables the fluid that exits drill bit 100 through exit port 110 to more easily escape out of the drilled hole, along with fragments of the material being drilled. Passageway 126 allows for slight misalignment of drill bit 100 with the drilled hole, which can be helpful in hand drilling.

As discussed herein, exit port 110 facilitates delivery of fluid from fluid conduit 108 to working portion 106. In particular, exit port 110 includes an exit channel 128 that enables fluid communication between fluid conduit 108 and the surfaces of working portion 106. Exit channel 128 is a hole formed near the end of drill bit 100. As illustrated in FIGS. 2 and 3, exit channel 128 has a longitudinal axis B that is offset and substantially parallel to the longitudinal axis A of drill bit 100. Additionally, exit channel 128 at least partially overlaps longitudinal axis A of drill bit 100. In other words, longitudinal axis A of drill bit 100 extends through exit channel 128.

The overlapping of exit channel 128 and longitudinal axis A of drill bit 100 cooperate to define the diameter of the core formed during the drilling process. Specifically, if longitudinal axis B of exit channel 128 is collinear with longitudinal axis A of drill bit 100, the core diameter formed during the drilling process will be maximized. Alternatively, the further offset longitudinal axis B of exit channel 128 is from the longitudinal axis A of drill bit 100, the smaller the core diameter will be, so long as exit channel 128 at least partially overlaps longitudinal axis A of drill bit 100.

Exit port 110 also includes interior shoulder 122. Similar to exterior shoulder 120, interior shoulder 122 can be at least partially covered with an abrasive layer 124, as illustrated, to facilitate the cutting of material and milling of core fragments. In the illustrated embodiment, interior shoulder 122 is frusto-conically shaped, radially tapering toward exit channel 128 and expanding toward the end of drill bit 100. In other words, interior shoulder 122 has at least a first diameter and a second diameter. The first diameter of interior shoulder 122 is adjacent exit channel 128 and is substantially equal the diameter of exit channel 128. The second diameter of interior shoulder 122 is larger than the first diameter and is adjacent the end of drill bit 100.

In the illustrated embodiment, interior shoulder 122 forms an approximately 120° frusto-conical recess or countersink. It will be appreciated, however, that interior shoulder 122 can be formed with other angles or in other shapes so long as the diameter of interior portion 122 becomes larger as it extends away from exit channel 128.

The axially offset exit channel 128 and the radially expanding interior shoulder 122 combine to reduce or eliminate the problems associated with core extraction, core hang up, and fragment removal as discussed herein. In particular, as drill bit 100 drills into a material, exterior shoulder 120 will cut through the material to define the outer wall of the hole, while interior shoulder 122 creates and then breaks and mills up the core before the core extends into exit channel 128 or fluid conduit 108.

As drill bit 100 drills into a material, a tapered core of the drilled material begins to form with the diameter of the core being determined by the taper in the radially offset, yet axially overlapping exit channel 128, as described herein. The core is progressively reduced in diameter by interior shoulder 122 as it penetrates further into the cavity. Eventually, as the core diameter becomes smaller, its strength is reduced until the shear forces exerted by interior shoulder 122 cause the core to break off. Interior shoulder 122 and the axial offset between drill bit 100 and exit port 110 are designed so that the core does not remain intact and enter into exit channel 128 or fluid conduit 108.

Additionally, the fluid flowing through exit channel 128 helps to force the broken core fragments against interior shoulder 122, where a pinching action mills the fragments into even smaller pieces until the fluid flushes the core fragments out of the hole as discussed herein. By breaking and milling up the core with drill bit 100 in this manner, the problems associated with the core extending into and breaking off in fluid conduit 108 are reduced or eliminated.

While the above exemplary embodiment has been described with reference to a drill bit exit port that has a generally cylindrical exit channel and a generally frusto-conically shaped interior shoulder, it will be appreciated that other configurations of a drill bit exit port are contemplated within the scope of the present invention.

By way of example and not limitation, FIGS. 5-7 illustrate an alternative embodiment of a drill bit exit port according to the present invention. In particular, the embodiment of drill bit 200 illustrated in FIGS. 5-7 includes a shaft 202 having a coupling portion 204, a working portion 206, and an internal fluid conduit 208 which opens at working portion 206 through an exit port 210. Drill bit 200 can also include a fluid intake 216 to supply fluid to fluid conduit 208. Drill bit 200 can also be adapted to have a fluid supply collar mounted thereon.

Similar to drill bit 100, drill bit 200 is adapted to break off and mill up a core before the core enters into and breaks off in fluid conduit 208, thereby reducing wear, increasing penetration rate, and also reducing or preventing incidences of core material hanging up within or filling up drill bit 200 and the problems associated therewith or the problems associated with core extraction as described herein. The configuration of working portion 206, and in particular exit port 210, provides these advantages.

Working portion 206 includes exterior shoulder 220 and exit port 210. As illustrated in the Figures, exterior shoulder 220 has a generally squared or non-rounded configuration such that working portion 206 presents a generally flat working surface at the end of drill bit 200. Additionally or alternatively, exterior shoulder 220 can define one or more blade-type edges to facilitate drilling. Furthermore, exterior shoulder 220 can be covered with an abrasive layer 224, as illustrated, to facilitate the cutting of material. Abrasive layer 224 can include diamonds impregnated or otherwise disposed on exterior shoulder 220. Alternatively, abrasive layer 224 can comprise an etched or otherwise roughened surface on exterior shoulder 220.

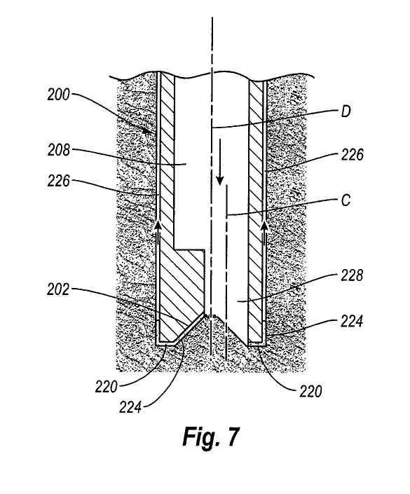

In some embodiments, abrasive layer 224 extends at least partially onto shaft 202. As illustrated in FIG. 7, inclusion of abrasive layer 224 on shaft 202 causes drill bit 200 to drill a hole that has a diameter larger than shaft 202, thereby creating a passageway 226 between shaft 202 and the wall of the drilled hole. Passageway 226 enables the fluid that exits drill bit 200 through exit port 210 to more easily escape out of the drilled hole, along with fragments of the material being drilled. Passageway 226 allows for slight misalignment of drill bit 200 with the drilled hole, which can be helpful in hand drilling.

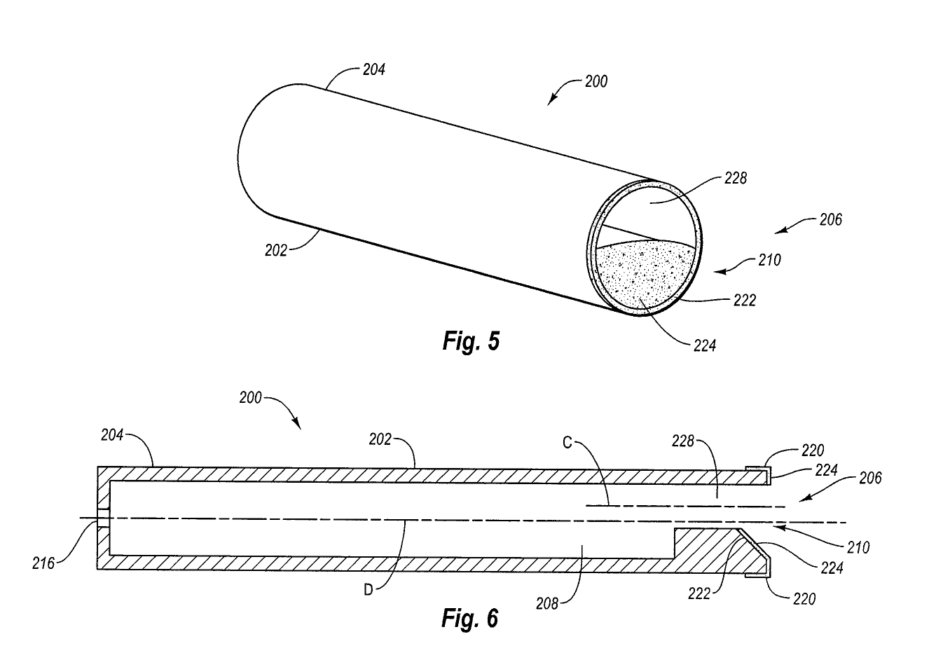

As discussed herein, exit port 210 facilitates delivery of fluid from fluid conduit 208 to working portion 206. In particular, exit port 210 includes an exit channel 228 that enables fluid communication between fluid conduit 208 and the surfaces of working portion 206. Exit channel 228 is a hole formed near the end of drill bit 200. As illustrated in FIG. 6, exit channel 228 has a longitudinal axis C that is offset and substantially parallel to the longitudinal axis D of drill bit 200. Additionally, exit channel 228 at least partially overlaps longitudinal axis D of drill bit 200. In other words, longitudinal axis D of drill bit 200 extends through exit channel 228.

As used herein, longitudinal axis C of exit channel 228 may refer to an axis of symmetry for exit channel 228 when exit channel 228 has a uniform shape, such as a circle. It will be appreciated, however, that when exit channel 228 has a non-uniform shape, such as the semi-circular shape illustrated in FIGS. 5 and 6, longitudinal axis C may refer to a line extending through both the axis of symmetry and the center of mass for the particular shape. In other words, longitudinal axis C may refer to a line extending through exit channel 228 and about which exit channel 228 would rotate if exit channel 228 were an unconstrained solid object of similar size and shape.

The overlapping of exit channel 228 and longitudinal axis D of drill bit 200 cooperate to define the diameter of the core formed during the drilling process. Specifically, if longitudinal axis C of exit channel 228 is collinear with longitudinal axis D of drill bit 200, the core diameter formed during the drilling process will be maximized. Alternatively, the further offset longitudinal axis C of exit channel 228 is from the longitudinal axis D of drill bit 200, the smaller the core diameter will be, so long as exit channel 228 at least partially overlaps longitudinal axis D of drill bit 200.

Exit port 210 also includes interior shoulder 222. Similar to exterior shoulder 220, interior shoulder 222 can be at least partially covered with an abrasive layer 224, as illustrated, to facilitate the cutting of material and milling of core fragments. In the illustrated embodiment, interior shoulder 222 has a generally semicircular, slightly concave shape that extends toward the interior of drill bit 200. It will be appreciated, however, that interior shoulder 222 is not limited to the illustrated shape. For example, interior shoulder 222 can present a substantially flat face at the end of drill bit 200. Furthermore, interior shoulder 222 can be formed in other, non-semicircular shapes without departing from the present invention so long as the drilled material forms a generally conical core and interior shoulder 222 causes side forces that break off the core before it enters into exit channel 228 or fluid conduit 208. By way of illustration, interior shoulder 222 can be formed with a circular, semicircular, or polygonal cross section.

The axially offset and overlapping exit channel 228 and interior shoulder 222 combine to reduce or eliminate the problems associated with core extraction, core hang up, and fragment removal as discussed herein. In particular, as drill bit 200 drills into a material, exterior shoulder 220 will cut through the material to define the outer wall of the hole, while interior shoulder 222 defines the tapered shape of the core and then breaks off and mills up the reduce diameter portion of the core before the core extends significantly into exit channel 228 or fluid conduit 208.

More specifically, as drill bit 200 drills into a material, a tapered core of the drilled material begins to form with the diameter of the core being determined by the taper in the radially offset, yet axially overlapping exit channel 228, as described herein. The core is progressively reduced in diameter by interior shoulder 222 as it penetrates further into the cavity. Eventually, as the core diameter becomes smaller, its strength is reduced until the shear forces exerted by interior should 222 cause the core to break off. Interior shoulder 222 and the axial offset between drill bit 100 and exit port 210 are designed so that the core does not remain intact and enter into exit channel 228 or fluid conduit 208.

Additionally, the fluid flowing through exit channel 228 helps to force the broken core fragments against interior shoulder 222, where a pinching action mills the fragments into even smaller pieces until the fluid flushes the core fragments out of the hole as discussed herein. By breaking and milling up the core with drill bit 200 in this manner, the problems associated with the core extending into and breaking off in fluid conduit 208 are reduced or eliminated.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A drill bit, comprising:
a shaft having a first end, a second end, and a central longitudinal axis, said first end of said shaft being adapted to be held by a drive unit, said shaft defining an interior fluid conduit adapted to receive a fluid therein through a fluid intake; and
a working portion disposed at the second end of said shaft, said working portion comprising:
an exterior shoulder;
an interior shoulder adapted to:
form a generally conical shaped core in a material being drilled, and
exert shear forces on the core so as to break off the core and mill up the core fragments to prevent the core from entering into said fluid conduit; and
an exit channel in fluid communication with said fluid conduit, said exit channel having a longitudinal axis that is offset from said central longitudinal axis of said shaft, said exit channel at least partially overlapping said central longitudinal axis of said shaft.

2. A drill bit as recited in claim 1, wherein said interior shoulder is generally frusto-conically shaped.

3. A drill bit as recited in claim 1, wherein said interior shoulder has a first radius and a second radius, wherein said second radius is larger than said first radius.

4. A drill bit as recited in claim 3, wherein said first radius is adjacent said exit channel and said second radius is distant from said exit channel.

5. A drill bit as recited in claim 1, wherein said exit channel is adapted to communicate a fluid from said fluid conduit to said interior and exterior shoulders.

6. A drill bit as recited in claim 1, wherein said shaft further comprises a mounting portion for mounting a fluid supply collar on said shaft.

7. A drill bit as recited in claim 6, wherein said mounting portion is adapted to communicate fluid from the fluid supply collar to said fluid conduit through said fluid intake.

8. A drill bit as recited in claim 1, wherein at least a portion of each of said exterior shoulder and said interior shoulder comprise an abrasive surface.

9. A drill bit as recited in claim 8, wherein said abrasive surface comprises diamonds.

10. A drill bit, comprising:
a coupling portion adapted to be held and rotated by a drive unit;
a mounting portion adapted to a have a fluid supply collar mounted thereon, the mounting portion comprising a fluid intake adapted to communicate fluid from the fluid supply collar to a fluid conduit within said drill bit; and
a working portion comprising:
an exterior shoulder;
a countersink disposed in said exterior shoulder; and
an exit channel adapted to communicate fluid from said fluid conduit to said countersink and said exterior shoulder, said exit channel at least partially overlapping and being axially offset from a central axis of said drill bit, wherein said exit channel is adapted to minimize the size of a core formed in a material during the drilling process, and wherein said countersink is adapted to further reduce the size of the core, break off the core, and mill up the core fragments to prevent the core from entering into said fluid conduit.

11. A drill bit as recited in claim 10, wherein said countersink is generally frusto-conically shaped with a narrow portion adjacent said exit channel and a wider portion opening at an end of said drill bit.

12. A drill bit as recited in claim 10, wherein said exterior shoulder decreases from a first diameter to a second diameter adjacent an end of said drill bit.

13. A drill bit as recited in claim 10, wherein each of said exterior shoulder and said countersink are impregnated or coated with an abrasive material.

14. A drill bit as recited in claim 13, wherein said abrasive material comprises diamonds.

15. A drill bit as recited in claim 10, wherein said exit channel has a generally semicircular shape.

16. A drill bit as recited in claim 10, wherein said mounting portion further comprises at lest one groove to facilitate coupling of a fluid supply collar on said drill bit.

17. A drill bit, comprising:
a shaft having a fluid intake for receiving a fluid within a fluid conduit disposed within said shaft; and
a working portion disposed at a first end of said shaft, said working portion having an exterior shoulder and an exit port comprising an exit channel and an interior shoulder, wherein:
said exit channel is in fluid communication with said fluid conduit so as to enable delivery of a fluid from said fluid conduit to said exit port and said exterior shoulder, said exit channel having a central axis that is offset from a central axis of said drill bit, said central axis of said drill bit extending through said exit channel, wherein said exit channel is adapted to reduce the diameter of a core formed during the drilling process; and
said exterior shoulder radially decreases and said interior shoulder radially increases near said first end of said shaft such that said exterior shoulder and said interior shoulder meet at an apex at said first end of said shaft, said exterior shoulder and said interior shoulder being adapted to drill a hole in a material when said drill bit is rotated about said central axis of said drill bit, said interior shoulder is further adapted to break off and mill up a core formed during the drilling process to prevent the core from entering said fluid conduit.

18. A drill bit as recited in claim 17, wherein said interior shoulder is generally frusto-conically shaped.

19. A drill bit as recited in claim 17, wherein said exit channel has a radius and said interior shoulder has a first radius adjacent said exit channel, wherein said exit channel radius and said first interior shoulder radius are substantially equal.

20. A drill bit as recited in claim 17, wherein at least a portion of each of said exterior shoulder, said interior shoulder, and said shaft are impregnated or coated with an abrasive material.
